(19) United States
(12) Patent Application Publication
(10) Pub. No.: US 2025/0061173 A1
(43) Pub. Date: Feb. 20, 2025

(54) Method of Evaluating a Data Set with Regard to Suitability for Determining a Calculation Function of a Virtual Sensor

(71) Applicant: Robert Bosch GmbH, Stuttgart (DE)

(72) Inventors: Matthias Woehrle, Bietigheim-Bissingen (DE); Konrad Groh, Stuttgart (DE); Michael Hilsch, Gaertringen (DE)

(21) Appl. No.: 18/804,485

(22) Filed: Aug. 14, 2024

(30) Foreign Application Priority Data
Aug. 15, 2023 (DE) 10 2023 207 816.3

(51) Int. Cl. G06F 18/214; G06F 18/22

(52) U.S. Cl. CPC G06F 18/2155; G06F 18/22

(57) ABSTRACT

A method for evaluating a data set with regard to suitability for determining a calculation function of a virtual sensor includes providing the data set. The data set includes measurement data resulting from a measurement of measured variables by at least two real sensors. The measurement data has a particular dimension for one of the at least two real-world sensors. The method further includes providing an input range defined for the measured variables of the at least two real sensors to specify at least one requirement for determining the calculation function. The method further includes determining a coverage ratio between the data set and the provided input range using a machine learning model, and evaluating the data set based on the determined coverage ratio.

This application claims priority under 35 U.S.C. § 119 to patent application no. DE 10 2023 207 816.3, filed on Aug. 15, 2023 in Germany, the disclosure of which is incorporated herein by reference in its entirety.

The disclosure relates to a method for evaluating a data set with regard to suitability for determining a calculation function of a virtual sensor. The disclosure also relates to a computer program, a device, and a storage medium for this purpose.

### BACKGROUND

Selecting appropriate data sets for virtual sensors can be difficult for several reasons. First, the effectiveness of a virtual sensor will particularly strongly depend on the quality and relevance of the underlying data. Data that is inaccurate, incomplete, or not representative of the intended operating conditions may result in malfunctions or inaccurate predictions. Second, differences in operating conditions or in the context between the data sources and the planned deployment of the virtual sensor may limit the applicability of the data. Finally, technical aspects such as the need to integrate data from various sources or process and store large data sets may also make it difficult to select appropriate data sets.

In the design of experiments, data sets are collected in the prior art, for example with prior knowledge, or also with classical Design of Experiment (DoE) methods. For example, a known DoE method is Response Surface Methodology based on simple approximation models such as linear models or splines. In particular, DoE methods consider how a function or virtual sensor changes over an input range. Further, for example, various test methods are known that analyze whether sufficient data is present in sub-areas.

Nevertheless, determining a sufficient amount of data is particularly difficult for non-linear virtual sensors. For example, this may make it additionally difficult to establish the reliability of a virtual sensor.

DE 10 2021 212 737A describes a computer-implemented method for checking test and/or training data sets for a computer-based machine learning module. DE69800186T2 describes virtual vehicle sensors based on neural networks, which are taught using data generated by simulation models. The “Machine Learning and Data Mining” section of the book “Basic Course in Artificial Intelligence: A practical introduction” by Wolfgang Ertel describes a technical overview of the topic of machine learning and data mining.

### SUMMARY

The subject matter of the disclosure is a method having the features of claim 1, a computer program having the features of claim 7, a device having the features of claim 8, and a computer-readable storage medium having the features of claim 9. Further features and details of the disclosure will emerge from the respective dependent claims, the description, and the drawings. Features and details which are described in connection with the method according to the disclosure naturally also apply in connection with the computer program according to the disclosure, the device according to the disclosure and the computer-readable storage medium according to the disclosure, and vice versa in each case, so that reference is or can always be made to the individual aspects of the disclosure with respect to the disclosure.

The subject matter of the disclosure is in particular a method of evaluating a data set with regard to suitability for determining a calculation function of a virtual sensor, comprising the steps of:
providing the data set, wherein the data set comprises measurement data, wherein the measurement data results from a measurement of measured variables by at least two real sensors, wherein the measurement data has a particular dimension for one of the at least two real sensors,
providing an input range, wherein the input range is defined for the measured variables of the at least two real sensors to specify at least one requirement for determining the calculation function,
determining a coverage ratio between the data set and the provided input range using a machine learning model,
evaluating the data set based on the determined coverage ratio.

The calculation function of the virtual sensor allows a calculation of a further measured variable, in particular on the basis of the measured data of the at least two real sensors. This further measured variable can be difficult to directly measure or not be directly measured, for example, and therefore can advantageously be determined indirectly via further measurements of the real sensors by the virtual sensor. A staggered arrangement is also conceivable so that the measurement data results from a measurement of further virtual sensors, which, in turn, can be based on a measurement of real sensors. Alternatively, for example, a real and a virtual sensor could also provide the data set for the calculation function of the virtual sensor by corresponding measurements. Accordingly, a virtual sensor is a software function, for example, with which non-measurable or difficult to measure variables can be derived from other, measurable or available sensor data and information. For example, the requirement for determining the calculation function may be that the respective real sensor be in a range allowable for that sensor. For example, it is conceivable for a temperature sensor to be given a range, based on physical properties of the temperature sensor, in which the temperature sensor outputs reliable measurement results. In other words, the coverage area describes in particular what proportion of the data set covers the input range. The input range may represent a range in which data points of the data set theoretically appear or may be measured or determined. The machine learning model, in one example, may additionally determine the calculation function of the virtual sensor. Alternatively, the calculation function of the virtual sensor may be determined, for example, by a further machine learning model. From the coverage range, a quality of the data set may be described with respect to suitability for determining the calculation function of the virtual sensor. This can be subsequently advantageous to improve the data set or future data sets and thus also improve the virtual sensor, whereby, for example, a risk can be reduced when using the virtual sensor, for example in an autonomous system.

In addition, in the context of the disclosure, it is conceivable that the input range is defined by a range between a respective minimum and a maximum value for each of the at least two real sensors, wherein the range between the respective minimum and maximum value represents a reliable range of the respective real sensor. In other words, the reliable range refers in particular to a range for which the real sensor is designed. This may be due to physical properties of the real sensor. The range between the minimum and maximum value may be predetermined by a specification of the respective real sensor. By defining the range for each of the real sensors, advantageously only measurement data from the reliable range of the respective real sensor can be considered and used for the calculation function of the virtual sensor. The input range may further be defined taking into account knowledge of physical backgrounds or characteristics regarding common domains of the respective real sensors. It is also conceivable, alternatively, that the input range is defined as at least one sub-area between the respective minimum and maximum value for each of the at least two real sensors, in order to determine the coverage ratio in the at least one sub-area. For example, the range between the respective minimum and maximum value for each of the at least two real sensors may be divided into at least two sub-areas to determine the coverage ratio in the at least two sub-areas. It is thus advantageously possible to compare the coverage ratios of the at least two sub-areas.

It may further be possible that determining the coverage ratio further comprises the steps of:
calculating an extension range for each data point of the data set to determine the coverage ratio based on the calculated extension range of the data points, wherein the extension range is specific for a range covered by the respective data point in the input range.

In other words, the extension range preferably represents an area for which knowledge extracted by the machine learning model can be assumed to be covered by the respective data point.

A further advantage may be achieved in the context of the disclosure if calculating the extension range further comprises the following step:
determining a next adjacent data point for each of the data points of the data set to calculate the extension range based on a linear model, particularly a local linear model, using the data point and the next adjacent data point, wherein a maximum radius of the extension range respectively reaches to the next adjacent data point of each data point, at a maximum.

The next adjacent data point is particularly selected as a limit, since from the next adjacent data point, the next adjacent data point itself provides better information regarding the coverage ratio and furthermore, in particular also the calculation function of the virtual sensor. The linear model preferably describes a relationship, in particular a straight line, between the respective data point and the respective next adjacent data point.

Preferably, the disclosure may provide that the method further comprises the following steps:
selecting a respective data point,
determining a next adjacent data point of the selected data point,
determining a local model of the selected data point using the machine learning model,
determining a linear model, wherein the linear model describes a relationship between the selected data point and the next adjacent data point,
comparing the local model and the linear model to calculate the extension range based on a deviation between the local model and the linear model.

The local model may be approximated based on respective values for weights of the machine learning model for the respective data point, and preferably may be a local linear model. In other words, the extension range is in particular derived from the machine learning model. The machine learning model preferably characterizes an extracted knowledge from the data. A local-linear hypothesis may be assumed based on the machine learning model. This hypothesis is tested in particular and the extension range can be determined depending on the fulfillment of this hypothesis.

A further advantage in the context of the disclosure can be achieved if the method further comprises the following step:
extending the data set with further data points to increase the coverage ratio of the data set by the further data points, wherein the further data points lie in an area of the input range not covered by the data set.

Extending the data set may be advantageous to increase the quality of the data set for determining the calculation function of the virtual sensor. Thus, a higher coverage ratio may advantageously help the virtual sensor provide more reliable outputs. Extending by the further data points in the area not covered by the data set may occur in various ways, for example randomly or by determining a distance between individual data points and providing a respective new data point at a center of the respective determined distance. The extension of the data set by further data points is preferably performed until the coverage ratio has exceeded a defined threshold value.

It is further conceivable that the calculation function of the virtual sensor will be applied to a calculation of an injection amount of an injector of an engine, wherein the method comprises the steps of:
providing the data set, wherein the data set comprises measurement data, wherein the measurement data results from a measurement of measured variables by the at least two real sensors, wherein the at least two real sensors measure at least one pressure and/or temperature, wherein the measurement data has a particular dimension for at least two real sensors, respectively, providing the input range, wherein the input range is defined for the measured variables to specify the at least one requirement for determining the calculation function, wherein the input range represents a range having at least two dimensions for which the at least two real sensors are specified,
determining a coverage ratio between the data set and the provided input range using a neural network, wherein the neural network comprises a linear activation function, wherein the coverage ratio expresses how much of the input range is covered by the data set,
evaluating the data set based on the determined coverage ratio.

The calculated injection amount of the injector may be advantageously used for a calibration of the injector of the engine.

It is possible that the method according to the disclosure is used in a vehicle. The vehicle can, for example, be designed as a motor vehicle and/or a passenger vehicle and/or an autonomous vehicle. The vehicle can comprise a vehicle device, e.g., for providing an autonomous driving function and/or a driver assistance system. The vehicle device can be designed to control and/or accelerate and/or brake and/or steer the vehicle, at least partially automatically.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure will emerge from the following description, in which embodiment examples of the disclosure are described in detail with reference to the drawings. The features mentioned in the claims and in the description can each be essential to the disclosure individually or in any combination. Shown are:

FIG. 1 a schematic visualization of a method, a device, a storage medium, and a computer program according to exemplary embodiments of the disclosure,

FIG. 2 a schematic illustration of an input range, a data set, and an extension range according to exemplary embodiments of the disclosure, and

FIG. 3 a schematic illustration of an engine, a virtual sensor, and a real sensor according to exemplary embodiments of the disclosure.

### DETAILED DESCRIPTION

FIG. 1 schematically illustrates a method 100, a device 10, a storage medium 15, and a computer program 20 according to exemplary embodiments of the disclosure.

FIG. 1 shows a method 100 for evaluating a data set with regard to suitability for determining a calculation function of a virtual sensor in accordance with exemplary embodiments of the disclosure. In a first step 101, preferably the data set is provided, wherein the data set comprises measurement data, wherein the measurement data results from a measurement of measured variables by at least two real sensors, wherein the measurement data has a respective dimension for one of the at least two real sensors. In a second step 102, preferably, an input range is provided, wherein the input range is defined for the measured variables of the at least two real sensors to specify at least one requirement for determining the calculation function. In a third step 103, a coverage ratio between the data set and the provided input range may be determined using a machine learning model. In a fourth step 104, the data set may be evaluated based on the determined coverage ratio.

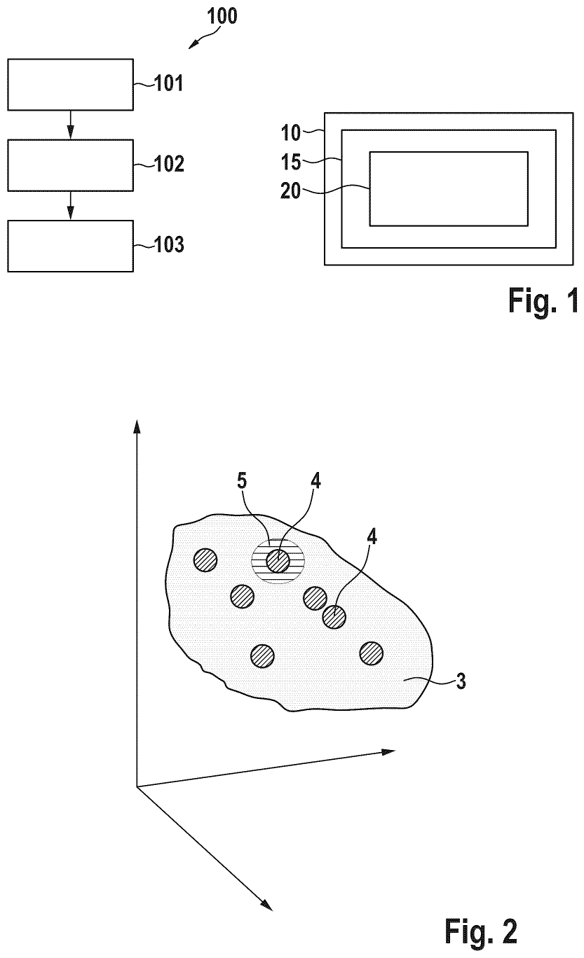

FIG. 2 schematically shows an input range 3, in which there is a plurality of data points 4 of the data set. To determine the coverage ratio, according to exemplary embodiments of the disclosure, an extension range 5 can be calculated around each of the data points 4.

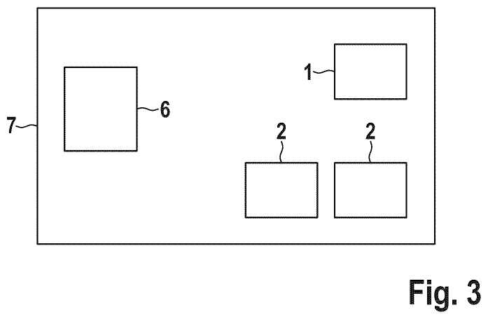

FIG. 3 schematically illustrates an engine 7 comprising an injector 6, a virtual sensor 1, and two real sensors 2.

In particular, a measure is described by the coverage ratio, which allows a statement to be made as to whether there are enough data points 4 in a data set with respect to a function to be learned from a virtual sensor 1. This may be performed using a neural network.

Preferably, an approximation model is adjusted to a variability of the data, and a measure is derived therefrom that indicates how well the data can characterize the variability of the virtual sensor 1 in an output space. The data quality is preferably determined iteratively. In comparison to classical Design of Experiment (DoE) methods, more complex functional models can be mapped using neural networks.

The disclosure may be used for analysis of data obtained from a real sensor 2. The real sensor 2 may determine measurements of the environment in the form of sensor signals, which may be given, for example, by certain data, namely sensor values of a system from which an immeasurable variable is to be derived, such as an injection mass consisting of quantities that characterize the pressure or other physical variables in connection with operation of an injector.

To provide the virtual sensor 1, information about the elements encoded by the sensor signal may be obtained based on the sensor signal, i.e., an indirect measurement may be made based on the sensor signal used as the direct measurement.

The disclosure may further be used to calculate a control signal for controlling a technical system, such as a computerized machine, a robotic system, a vehicle, a domestic device, a power tool, a manufacturing machine, a personal assistant, or an access control system. The virtual sensor 1 is in particular used for control and regulation of the system, for example the injection event may be (better) controlled.

The method of the disclosure may be used to generate test, verification, and/or validation data to test whether the trained ML system can be operated safely.

The quality level according to exemplary embodiments of the disclosure particularly allows the derivation of data ranges, in which data points 4 are absent. Further data points 4 can then be collected locally in this range. Existing data points 4 preferably serve as prototypes for generating further data points 4. Furthermore, it may not only be important to achieve coverage, but also to determine which range this coverage allows.

In a first step, a machine learning model can be trained based on a DoE model, in particular Response Surface. Based on this network and the coverage ratio, preferably new data points 4 are generated. The data point generation step is preferably performed until the coverage ratio of the data set has exceeded a defined threshold value. The threshold value of the coverage ratio may vary across the input range.

Quality of the data set may be read from the coverage ratio. This may apply to training, validation, and test data. This can subsequently be advantageous to improve the data sets and thus also to improve the virtual sensor 1 or in relation to test data sets and to reduce the risk when using the virtual sensor 1 in an autonomous system.

In particular, an incremental approach for determining the coverage ratio is described below. The approach is preferably based on a main component analysis (PCA)-based dimension reduction and k-d-tree-based partitioning of the input range.

FIG. 2 provides an overview of a possible embodiment of the approach. Starting from an assessment of the quality of a prediction for a data point 4, it is determined how each data point 4 can be locally generalized under certain assumptions, which is shown with the extension range 5.

One idea behind the approach is in particular to consider the regression task and a corresponding requirement for the error limits. Preferably, because a virtual sensor 1 is viewed, the task may be a regression task and the machine learning model may be in the form of y=f(x), whereby y∈ [symbol] and x∈ [symbol] ⁿ preferably is a vector of physical variables. The fundamental truth label x associated with a point may be referred to as a label function g. In other words, the label function g preferably represents a true value of the sensor derived from x.

First, a requirement for the absolute accuracy of the prediction and a limitation of the error may be formulated: e(x)=|g(x)−f(x)|≤ϵ. A goal may be to find a sphere B around xₖ, wherein xₖ is a respective data point 4, with the radius rₖ, that is Bᵣₖ. In particular, this sphere B(xₖ) determines a part of the input range, which can be assumed to be covered. This is in particular the circle, or extension range 5, by the data points 4 in FIG. 2. Some desiderates that may be considered for a point xₖ are those below. If the prediction error in the data point is too large: (e(xₖ)>ϵ), the sphere with radius rₖ=0 may be degenerated. If (e(xₖ)<ϵ) is given, then the smaller e(xₖ) is, the larger the radius rₖ can be. The increase in the detection range is determined in particular not only by the local point xₖ, but preferably primarily by how the true underlying function g(x) and accordingly e(x) in the vicinity of xₖ.

In particular, neither g(x) is nor f(x) is known. As such, assumptions are preferably made to determine the coverage. For illustration, an intuitive approach can be taken that is based on local linear models. Because the machine learning model preferably models a comparable model, this assumption may advantageously fit with the model class of the machine learning model. In particular, for the representation of g(x), the nearest data point 4 may be chosen, i.e., the nearest neighbor x_{NN,k}, as the closest sample of g(x) in the neighborhood of xₖ and for its local representation. The maximum radius of B(xₖ) may be limited to a distance from the nearest neighbor, i.e. B_{|x}_{_{K}}₋ₓ_{_{NN,k}}_{|}. Further, f(x) locally may be approximated as a linear model f implied by the (activation-adjusted) weights in xₖ. Similarly, g(x) may be locally linear and interpolated based on the values of xₖ and x_{NN,k}, which is particularly referred to as ĝ in the context of the disclosure. In the following sections, for example, both linear approximations are used and ê(x)=|ĝ(x)−\hat{f}(x)| calculated.

A motivation behind this approach may be a what would be if analysis, determining whether the local model \hat{f}ₓ_{ₖ} is sufficient to capture the local variability of xₖ and x_{NN,k}, or whether a change to the model would be required. It is preferably possible that the point at which the difference between ĝ(x) and \hat{f}(x) is greater than e determines the sphere's radius. While \hat{f}(xₖ) may still be within the e-boundary, in the context of the disclosure, \hat{f}(x_{NN,k}) is particularly used to determine the radius of the covering sphere, i.e., the prediction of the local linear approximation \hat{f}ₓ_{ₖ}.

Based on this formulation, the radius rₖ of the covering sphere B(xₖ) may be determined as rₖ=s*|xₖ−x_{NN,k}| with s∈[0,1], wherein

$$s = min ( 1 , max ( 0 , \frac{ϵ - \hat{e} ( {x}_{k} )}{\vert \hat{e} ( {x}_{NN , k} ) - \hat{e} ( {x}_{k} ) \vert} ) ) .$$

The entire input range 3 may be limited by the training range T⊆ [symbol] ⁿ, because in particular, no unreliable predictions that occur outside of this range should be risked. In order to achieve coverage of the input range, it may be desirable for a set of data points X to cover the unification of the spheres around the data points 4 of the training area T−Uₓ_{ₖ}_{∈X}B(xₖ)=Ø, or, intuitively, for the spheres of FIG. 2 to cover the area. If T is covered by the data point coverage of a data set, it can be argued that the data set is sufficiently tightly sampled from the perspective of the coverage under the abovementioned assumptions and/or determined how much of the input range 3 is covered.

The previous description in particular uses a sphere, i.e., a uniform extension into different dimensions with regard to the measured variables. However, the approach can also be simply expanded to include physical prior knowledge with regard to different extensions along different dimensions.

Preferably, a k-d tree approach is used, i.e., in particular, a hyperbox, to provide the data sets with all their advantages, e.g., simplicity and interpretability, and disadvantages, e.g., proximity to boundary points. In possible experiments, some of the models mentioned above may be selected with different dimensions and their coverage may be compared. In particular, (i) the coverage in individual sub-areas of the input range provided by the k-d tree, as well as (ii) the center coverage across these areas, may be analyzed. Further, a percentage of the covered input range may be approximated by Monte Carlo samples, i.e., a sample may be taken from T and checked how many points are within Uₓ_{ₖ}_{∈X}B(xₖ).

Machine learning models having a smaller input dimensionality may have better coverage than larger machine learning models. Further, it may be determined that the coverage across the input range may vary greatly between smaller and larger machine learning models. This may be due to two reasons: (i) the predictions may have a large error, or (ii) the machine learning models may change greatly in a particular part of the input range. In addition, better or worse performance within a particular range of data may be consistent across different machine learning model sizes. This may imply that, in various instances, critical data ranges may also be identified that worsen the coverage and thus increase the evaluation risk and potentially machine learning model performance due to lack of training data.

The above explanation of the embodiments describes the disclosure solely within the scope of examples. Of course, individual features of the embodiments can be freely combined with one another, if technically feasible, without leaving the scope of the disclosure.

What is claimed is:

1. A computer-implemented method of evaluating a data set with respect to suitability for determining a calculation function of a virtual sensor, the method comprising:
providing the data set, wherein the data set comprises measurement data resulting from a measurement of measured variables by at least two real sensors, wherein the measurement data has a particular dimension for the at least two real sensors;
providing an input range defined for the measured variables of the at least two real sensors to specify at least one requirement for determining the calculation function;
determining a coverage ratio between the data set and the provided input range using a machine learning model;
evaluating the data set based on the determined coverage ratio; and
expanding the data set by further data points to increase the coverage ratio of the data set by the further data points, wherein the further data points lie in a non-covered area of the input range by the data set.

2. The computer-implemented method of claim 1, wherein:
the input range is defined by a range between a respective minimum and a maximum value for each of the at least two real sensors, and
the range between the respective minimum and maximum value represents a reliable range of a respective real sensor of the at least two real sensors.

3. The computer-implemented method according to claim 1, wherein determining the coverage ratio further comprises:
calculating an extension range for each data point of the data set to determine the coverage ratio based on the calculated extension range of the data points,
wherein the extension range is specific for a range covered by a respective data point in the input range.

4. The computer-implemented method according to claim 3, wherein calculating the extension range further comprises:
determining a next adjacent data point for each of the data points of the data set to calculate the extension range based on a linear model using the data point and the next adjacent data point,
wherein a maximum radius of the extension range reaches to the next adjacent data point of each data point, at a maximum.

5. The computer-implemented method according to claim 3, wherein calculating the extension range further comprises:
selecting a respective data point;
determining a next adjacent data point of the selected data point;
determining a local model of the selected data point using the machine learning model;
determining a linear model describing a relationship between the selected data point and the next adjacent data point; and
comparing the local model and the linear model to calculate the extension range based on a deviation between the local model and the linear model.

6. The computer-implemented method according to claim 1, wherein the calculation function of the virtual sensor is applied for a calculation of an injection amount of an injector of an engine, and the method further comprises:
providing the data set comprising the measurement data resulting from the measurement of measured variables by the at least two real sensors, the at least two real sensors measuring at least one pressure and/or temperature, wherein the measurement data have the particular dimension for one of the at least two real sensors, respectively;
providing the input range defined for the measured variables in order to specify the at least one requirement for determining the calculation function, wherein the input range represents a range with at least two dimensions for which the at least two real sensors are specified;
determining the coverage ratio between the data set and the provided input range using a neural network, wherein the neural network comprises a linear activation function, wherein the coverage ratio expresses how much of the input range is covered by the data set; and
evaluating the data set based on the determined coverage ratio.

7. The computer-implemented method according to claim 1, wherein a computer program comprises instructions that, when the computer program is executed by a computer, cause the computer to carry out the method.

8. A device for data processing, configured to carry out the method according to claim 1.

9. A non-transitory computer-readable storage medium, comprising instructions which, when executed by a computer, cause the computer to carry out the method according to claim 1.
